(19) United States
(12) Patent Application Publication
(10) Pub. No.: US 2011/0003210 A1
(43) Pub. Date: Jan. 6, 2011

(54) Polyolefin Microporous Membrane Surface-Modified By Hydrophilic Polymer, Surface Modification Method Thereof And Lithium-Ion Polymer Battery Including The Same

(75) Inventors: Dae Young Lim, Yongin-si (KR); Jun Young Kim, Seoul (KR)

Correspondence Address: REINHART BOERNER VAN DEUREN P.C., 2215 PERRYGREEN WAY, ROCKFORD, IL, 61107, US

(73) Assignee: KOREA INSTITUTE OF INDUSTRIAL TECHNOLOGY, Cheonan-si (KR)

(21) Appl. No.: 12/696,568

(22) Filed: Jan. 29, 2010

(30) Foreign Application Priority Data
Jul. 3, 2009 (KR) 10-2009-0060748

(51) Int. Cl. H01M 2/16; H01M 2/00

(52) U.S. Cl. 429/249; 427/569; 427/488

(57) ABSTRACT

Disclosed herein are a polyolefin microporous membrane of which surface is modified by a hydrophilic polymer, a surface modification method thereof and a lithium ion polymer battery including the surface-modified polyolefin microporous membrane as a separator.

The polyolefin microporous membrane of which surface is modified by a hydrophilic polymer minimizes membrane distortion by employing plasma-induced coating method and also increase the membrane's mechanical strength and heat resistance. In addition, the polyolefin microporous membrane enhances the ability of impregnating an electrolyte solution by increasing polarity and surface energy on its surface through modification to hydrophilic surface, and enhances the adhesion between a separator and an electrode, between a separator and an electrolyte solution or gel polymer electrolytes. Further, the lithium ion polymer battery including the polyolefin microporous membrane of which surface is modified by a hydrophilic acrylic polymer as a separator has enhanced cycle life and rate capability.

### BACKGROUND OF THE INVENTION

1. Field of the Invention

The present invention relates to a polyolefin microporous membrane of which surface is modified by a hydrophilic polymer, a surface modification method thereof and a lithium-ion polymer battery including the same, and in more particular, to a polyolefin microporous membrane of which surface is modified by coating a hydrophilic acrylic polymer uniformly on one side or both sides of the polyolefin microporous membrane by plasma-induced coating method, a surface modification method thereof and a lithium-ion polymer battery including the same.

2. Background of the Related Art

Recently, demand for a secondary battery used in a portable electronic product and an information telecommunication device are drastically increased and researches thereon are actively progressed as electricity, electronics, communication and computer industries are rapidly developed.

In particular, a lithium secondary battery is a field attracting much interest due to its high energy density, long cycle life, low self-discharge rate and high operating voltage. In particular, it is known that a lithium ion polymer battery has limitless industrial applicability adapted for a portable electronic product and an information telecommunication device having various designs because it can be comparatively easily manufactured in various shapes.

Further, research and commercialization for a lithium ion polymer battery with high capacity having both stability and high performance are urgently required as demand for a lithium secondary battery in high capacity is greatly increased because an electronic product and a portable device are recently being small in size and complex in function.

A separator that is one of main components constituting a lithium secondary battery is located between a cathode and an anode, and is known as a safety guard most greatly influencing the safety of the lithium secondary battery.

The separator is a porous film having micropore structure in uniform size, and serves to move lithium ions efficiently between electrodes through such micropore and prevent short circuit physically by direct contact between a cathode and an anode. Accordingly, a separator must have chemical or electrochemical stability, and mechanical strength endurable at certain outer shock and pressure. For example, if the separator is excessively contracted at high temperature or is disrupted by more than certain outer shocks, short circuit occurs due to direct contact between a cathode and an anode, thereby being direct cause for explosion of a lithium secondary battery. Accordingly, a separator must have superior thermal characteristics, dimensional stability and mechanical strength enough to endure at certain outer shock to ensure the stability of a lithium secondary battery.

A generally used polyolefin microporous membrane is made of polyethylene, polypropylene, polyvinylidene fluoride and a blend thereof, and is now being used as a separator in most of a lithium ion battery and a lithium ion polymer battery.

However, polyolefin separator alone cannot satisfy enhanced battery characteristics and stability accompanied by the need of slimming various devices required in the actual industrial field according to the recent rapid progress in the electrical-electronic communication device industries. Accordingly, the physical property of the existing polyolefin separator must be first improved in order to be applied as a separator of a high stability-high performance lithium ion polymer battery. In particular, slimming of the separator for the lithium ion battery and the lithium ion polymer battery according to the recent trend of slimming causes to weaken its mechanical strength and stability to dimension, thereby causing short circuit easily, and thus such slimming also causes large problems in the stability of the lithium ion secondary battery.

In order to solve the above problems and achieve the physical property required in the actual industrial field according to the recent slimming trend in the electrical-electronic communication devices, improvements in enhancing the mechanical strength of and characteristics of a battery are being attempted by incorporating various types of additives and reinforcing agents into the polyolefin separator. However, if much additives or reinforcing agents are used, many problems such as non-uniform mixing and dispersion within the polyolefin separator, decrease in workability, and rise in production costs due to much incorporation are caused. Further, there remain many problems to be solved in order to commercialize such attempt actually in consideration of commercial applicability against battery performance/production cost since the process requires many steps.

Meanwhile, it is known that the existing polyolefin separator cannot incorporate easily an organic solvent having high dielectric constant, for example, ethylene carbonate, propylene carbonate, gamma-butyrolactone, etc., mainly used in a lithium secondary battery by virtue of low surface energy of its hydrophobic surface, and has poor ability in conserving an electrolyte solution during charge-discharge of the lithium secondary battery. Further, the existing polyolefin separator has a shortcoming since it causes a phenomenon of leaking organic solvent between electrodes or between an electrode and a separator, thereby lowering the shelf life of the lithium secondary battery.

In order to solve those problems, researches for enhancing affinity, heat stability and mechanical characteristics of a separator with an organic solvent-based electrolyte solution by coating a gel polymer electrolyte on the separator are being progressed. However, there still remain many problems to be solved for actual commercialization thereof since its manufacturing process is complex and its production cost is relatively high.

In order to solve those problems, methods for modifying surfaces of the existing hydrophobic polyolefin separator by employing a hydrophilic polymer capable of increasing its surface energy for impregnating an organic solvent-type electrolyte solution easily are being attempted.

In this regard, the inventors tried to solve the problems caused by the hydrophobic surface while maintaining physical property of the separator made of the existing polyolefin microporous membrane, and thus completed the present invention by modifying the separator's surface with a hydrophilic polymer capable of increasing the surface energy of the hydrophobic polyolefin microporous membrane through dispersing a polymer on the membrane surface uniformly in nano size by employing plasma-induced coating method within a plasma reactor based on plasma process technology; thereby minimizing film distortion and also increasing the separator's mechanical strength and heat resistance, and simultaneously modifying the separator's surface with a hydrophilic polymer thereby enhancing battery characteristics.

### SUMMARY OF THE INVENTION

Accordingly, it is an object of the present invention to provide a polyolefin microporous membrane surface of which hydrophobic surface is modified by a hydrophilic polymer.

It is also an object of the present invention to provide a method of modifying a surface of a polyolefin microporous membrane by coating a hydrophilic polymer on the surface of the polyolefin microporous membrane with plasma-induced coating method.

Yet another object of the present invention is to provide a lithium-ion polymer battery including a surface-modified polyolefin microporous membrane as a separator.

To accomplish the above objects of the present invention, according to one aspect of the present invention, there is provided a polyolefin microporous membrane of which surface is modified by coating a hydrophilic polymer uniformly on one side or both sides of the polyolefin microporous membrane with plasma-induced coating method.

The hydrophilic polymer can be any one polymer selected from the group consisting of polyacrylonitrile, polyacrylic acid and polyacrylate; or any one selected from the group consisting of a derivative, a copolymer and a blend thereof in which a C₁˜C₁₀ alkyl group or a C₁˜C₁₀ alkoxy group is substituted on such polymer.

A polyolefin microporous membrane used in the present invention can be any one selected from the group consisting of polyethylene, polypropylene, polyvinylidene fluoride and poly(vinylidenefluoride hexafluoropropylene), or a mixed form selected from a copolymer thereof and a blend thereof. In the above, the blend form can be a microporous membrane form having a multi-layer structure made of polyethylene/polypropylene or polypropylene/polyethylene/polypropylene.

Yet another aspect of the present invention provides a method of modifying a surface of a polyolefin microporous membrane comprising the steps of activating a plasma reactor by feeding a reaction gas into the plasma reactor, and plasma-treating the polyolefin microporous membrane so that a hydrophilic polymer can be coated on one side or both sides of the membrane within the activated plasma reactor.

More particularly, the surface modification method according to the present invention is carried out in the way of coating a hydrophilic polymer on one side or both sides of the polyolefin microporous membrane by polymerizing monomers of the hydrophilic polymer by plasma treatment.

The hydrophilic polymer being used in the surface modification method of the present invention can be any one hydrophilic acrylic polymer selected from the group consisting of polyacrylonitrile, polyacrylic acid and polyacrylate; or any one selected from the group consisting of a derivative, a copolymer and a blend thereof in which a C₁˜C₁₀ alkyl group or a C₁˜C₁₀ alkoxy group is substituted on such polymer.

The pressure in the activated plasma reactor in the method of modifying a surface of a polyolefin microporous membrane by a plasma-induced coating method according to the present invention can be 0.01 to 1,000 mTorr, and the flux of the reaction gas in the activated plasma reactor can be 10 to 1,000 sccm.

Then, plasma-treating process is carried out at plasma power of 1 to 500 W and coating time of 30 seconds to 30 minutes.

Polyolefin microporous membrane used in the present invention can be prepared by at least one method selected from the group consisting of a dry process, a wet process, an extraction process and a mixed process thereof.

Yet another aspect of the present invention provides a lithium ion polymer battery including a separator that is a polyolefin microporous membrane of which surface is modified by a hydrophilic polymer; a cathode; an anode; and an organic solvent-type electrolyte solution or a gel polymer electrolyte.

The present invention provides a polyolefin microporous membrane of which surface is modified by a hydrophilic polymer by employing relatively simple and economical plasma-induced coating method, and thus can maintain pore characteristics, minimize membrane distortion and also increase the membrane's mechanical strength and heat resistance. In addition, the surface of polyolefin microporous membrane according to the present invention provides outstandingly enhanced ability of impregnating an electrolyte solution due to improvements of surface characteristics, e.g. increases in polarity and surface energy, through modification to hydrophilic surface, and thus provides high output power.

Further, the present invention uses a polyolefin microporous membrane of which surface is modified by a hydrophilic acrylic polymer as a separator for a lithium ion polymer battery. Accordingly, a lithium ion polymer battery of which shelf life or cycle characteristics is enhanced can be provided since the uniformity of the electrolyte solution impregnated in a battery and a gel polymer electrolyte is enhanced, and the adhesion between a separator and an electrode, between a separator and an electrolyte solution or gel polymer electrolytes is enhanced. In particular, the effect of enhancing the stability of a lithium ion polymer battery can be anticipated by using a polyolefin microporous membrane of which surface is modified by a hydrophilic acrylic polymer as a separator.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a graph showing X-ray photoelectron analysis results for the existing polyolefin microporous membrane;

FIG. 2 is a graph showing X-ray photoelectron analysis results for the polyolefin microporous membrane of which surface is modified with the surface modification method according to an embodiment of the present invention;

FIG. 3 is a graph showing high resolution spectra of C_{1S} core level for the surface of the polyolefin microporous membrane of FIG. 2;

FIG. 4 is a graph showing contact angle of the polyolefin microporous membrane according to an embodiment of the present invention;

FIG. 5 illustrates a SEM micrograph for the surface of the polyolefin microporous membrane according to an embodiment of the present invention;

FIG. 6 is a graph showing charge-discharge profiles of the lithium ion polymer battery according to an embodiment of the present invention versus that of the existing lithium ion polymer battery at room temperature; and

FIG. 7 is a graph showing rate capability of the lithium ion polymer battery according to an embodiment of the present invention versus that of the existing lithium ion polymer battery.

### DETAILED DESCRIPTION OF THE PREFERRED EMBODIMENT

Hereinafter, the present invention will be described in detail.

The present invention provides a polyolefin microporous membrane of which surface is modified by coating a hydrophilic polymer uniformly on one side or both sides of the polyolefin microporous membrane by plasma-induced coating method.

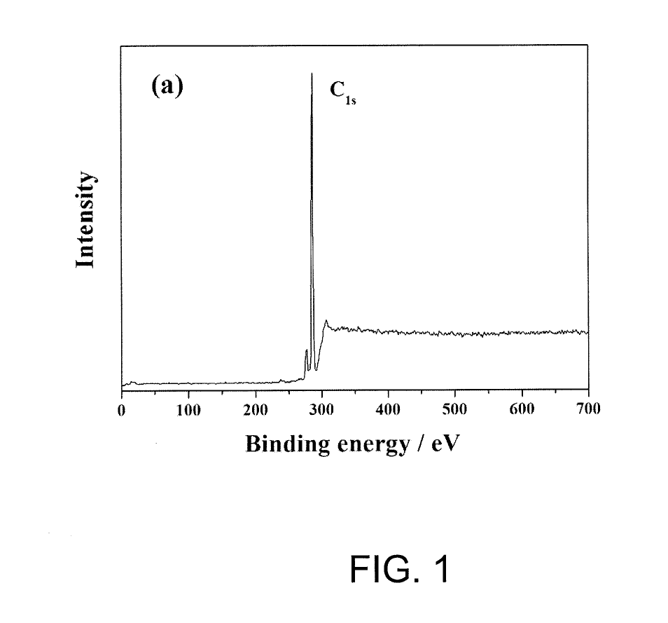

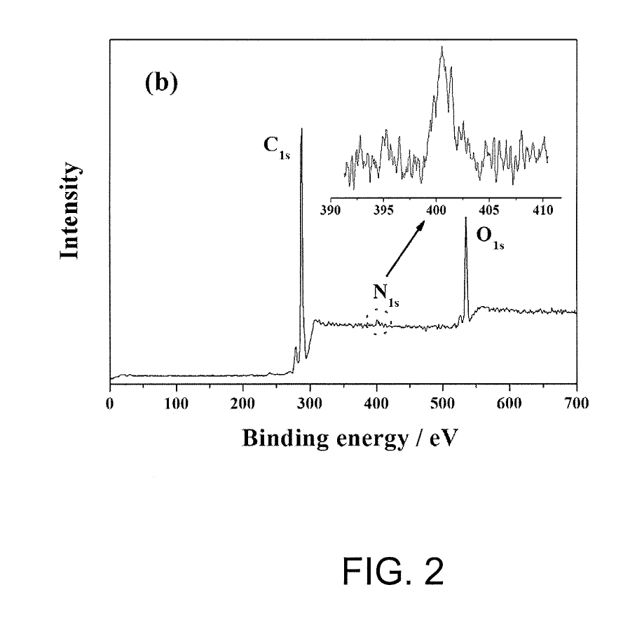

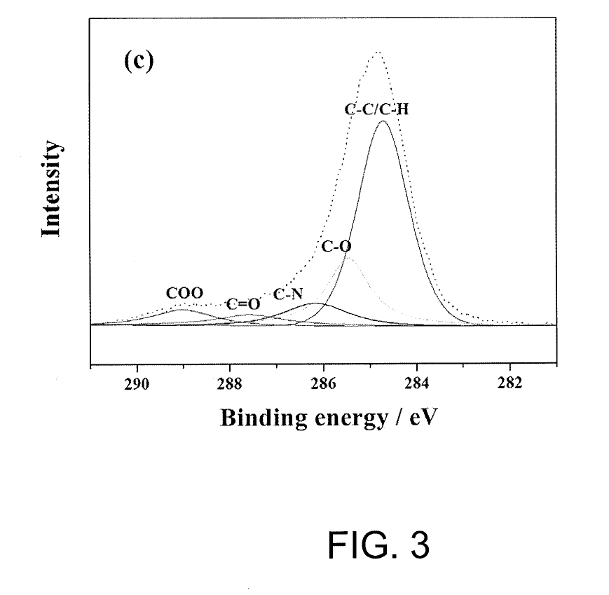

The surface of the polyolefin microporous membrane of the present invention of which surface is modified by a hydrophilic acrylic polymer was analyzed by X-ray photoelectron spectroscopy. From the analysis, it can be ensured that the hydrophilic acrylic polymer is stably coated on the surface of the polyolefin microporous membrane since functional groups of C—O, C—N, C═O, C—O—O and C—C/C—H are observed on the surface of the polyolefin microporous membrane according to present invention (FIGS. 2 and 3) in contrast with the existing polyolefin microporous membrane (FIG. 1). As it is shown that the contact angle of polyolefin microporous membrane according to the present invention was greatly decreased in contrast with the existing polyolefin microporous membrane from measurement of its contact angle, the surface of polyolefin microporous membrane according to the present invention obtains outstandingly enhanced ability of impregnating an electrolyte solution due to improvements of surface characteristics, e.g. increase in polarity and surface energy, and accordingly can provide the battery with high output of power.

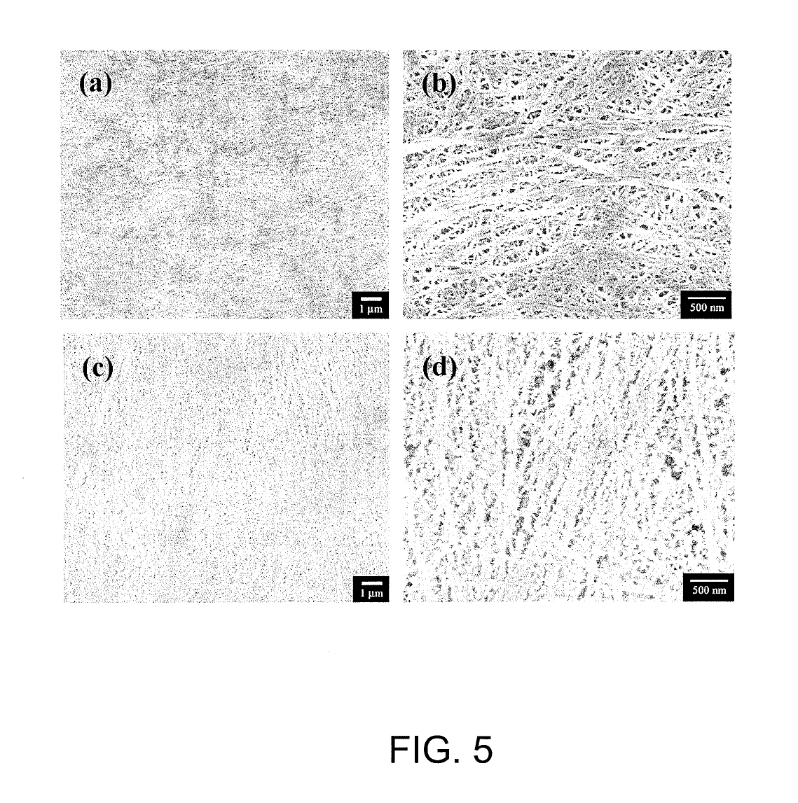

Further, the surface of the polyolefin microporous membrane of which surface is modified by a hydrophilic acrylic polymer according to the present invention was observed with a scanning electron microscope (SEM). From the SEM micrograph, dense network can be observed on the surface modified polyolefin microporous membrane according to the present invention (FIG. 5) since polymers in nano size are uniformly coated in distribution on the surface modified membrane in contrast with the existing polyolefin microporous membrane of which surface is not modified.

Furthermore, it can be ensured that the polyolefin microporous membrane of which surface is modified by a plasma-induced coating method according to the present invention has enhanced ion conductivity at room temperature and improved mechanical characteristics.

As described in the above, the surface modification method according to the present invention is carried out in the way of coating a hydrophilic polymer on one side or both sides of the polyolefin microporous membrane by polymerizing monomers of the hydrophilic polymer by plasma treatment, and in more particular, treating any one kind of acrylic monomer selected from the group consisting of acrylonitrile, acrylic acid and acrylate by a method of coating, spreading or dipping, etc. on the surface of the polyolefin microporous membrane and then polymerizing the monomers by plasma treatment.

In this regard, the hydrophilic polymer being formed on the surface of polyolefin microporous membrane according to the present invention can be any one hydrophilic acrylic polymer selected from the group consisting of polyacrylonitrile, polyacrylic acid and polyacrylate; or any one selected from the group consisting of a derivative, a copolymer and a blend thereof in which a C₁˜C₁₀ alkyl group or a C₁˜C₁₀ alkoxy group is substituted on such polymer.

The polyolefin microporous membrane according to the present invention is a porous film having micropore structure in uniform size. A porous film mainly used as a separator for a lithium ion polymer battery is an insulating thin film having high ion permeability and a required mechanical strength. The material constituting the film can be any one selected from the group consisting of polyethylene (PE), polypropylene (PP), polyvinylidene fluoride (PVDF), poly(vinylidenefluoride hexafluoropropylene (PVDF-HFP); or a mixed form selected from a copolymer or a blend thereof. A multilayer form such as a bilayer or a trilayer, e.g., polyethylene/polypropylene (PE/PP) and polypropylene/polyethylene/polypropylene (PP/PE/PP) can be also used as the above material.

Further, the polyolefin microporous membrane can be prepared by at least one method selected form the group consisting of a dry process, a wet process, an extraction process and a mixed process thereof. The polyolefin microporous membrane prepared by a dry process or an extraction process is more preferably used.

The present invention provides a method of modifying the surface of a polyolefin microporous membrane comprising the steps of activating a plasma reactor by feeding a reaction gas into the plasma reactor, and plasma-treating the polyolefin microporous membrane so that a hydrophilic polymer can be coated on one side or both sides of the membrane within the activated plasma reactor.

The method of modifying the surface of a polyolefin microporous membrane according to the present invention is carried out in the way of coating a hydrophilic polymer on the membrane surface uniformly in distribution in nano size by employing plasma-induced coating method within a plasma reactor based on plasma process technology.

The first step of the surface modification method according to the present invention is to activate a plasma reactor by feeding a reaction gas into the plasma reactor. The pressure in the activated plasma reactor can be 0.01 to 1,000 mTorr, and the flux of the reaction gas in the activated plasma reactor should be 10 to 1,000 sccm.

In this regard, the reaction gas is not particularly limited. If the flux of the reaction gas in the activated plasma reactor is less than 10 sccm, coating is not uniform, and if the flux exceeds 1,000 sccm, there is a problem that plasma is not generated due to the excess reaction gas.

Then, the second step is to plasma-treat the polyolefin microporous membrane so that a hydrophilic polymer can be coated on one side or both sides of the membrane within the activated plasma reactor.

In more preferable embodiment, a hydrophilic polymer is coated on both sides of a polyolefin microporous membrane through plasma treatment by dipping a polyolefin microporous membrane into a hydrophilic monomer-containing solution for preparing a hydrophilic polymer and feeding the treated membrane in the activated plasma reactor.

The hydrophilic polymer formed on the polyolefin microporous membrane after plasma treatment can be any one hydrophilic acrylic polymer selected from the group consisting of polyacrylonitrile, polyacrylic acid and polyacrylate; or any one selected from the group consisting of a derivative, a copolymer and a blend thereof in which a C₁˜C₁₀ alkyl group or a C₁˜C₁₀ alkoxy group is substituted on such polymer. The hydrophobic surface of the present invention is modified by the hydrophilic acrylic polymer.

The plasma reactor plasma-treats the polyolefin microporous membrane under the condition of plasma power of 1 to 500 W and plasma coating time of 30 seconds to 30 minutes. At this time, plasma power can be 1 to 500 W, and more preferably 100 to 400 W. If the plasma power exceeds 500 W, excessive heat occurs in the apparatus, and accordingly causes distortion of the separator or surface crack, thereby causing serious problems to the performance of the separator.

Further, the surface modification method according to the present invention can minimize membrane distortion and also increase the membrane's mechanical strength and heat resistance, and form the hydrophilic polymer on the membrane surface uniformly in nano size and shorten processing time greatly since the method according to the present invention is carried out by plasma coating method.

In this regard, plasma coating time according to the present invention is determined within a condition in which change in the structure and physical characteristics of a separator does not occur, and is preferably 30 seconds to 30 minutes. Accordingly, the method according to the present invention can modify the membrane surface in the plasma reactor with a relatively simple and economical method for a short time. At this time, if the plasma coating time is less than 30 seconds, uniform coating is not achieved, and if the plasma coating time exceeds 30 minutes, it is not preferable since distortion or surface crack of the separator occurs.

The surface characteristics of the polyolefin microporous membrane prepared by the surface modification method according to the present invention is improved since the surface modified polyolefin microporous membrane has increased polarity on the membrane surface and increased surface energy in contrast with the existing surface unmodified membrane. Further, according to the surface modification method of the present invention, adhesion between a separator and an electrode, between a separator and an electrolyte solution or gel polymer electrolytes is enhanced.

Accordingly, when the polyolefin microporous membrane prepared by the surface modification method according to the present invention is used as a separator, an ability of impregnating an electrolyte solution can be outstandingly enhanced, and thus the membrane can provide the battery with high output of power. Further, coating process employing plasma is most simple and efficient process since mass production and large capacity are achieved for actual commercialization.

The material of the polyolefin microporous membrane used in the surface modification method according to the present invention is the same as explained above. The polyolefin microporous membrane of which surface is to be modified can be prepared by at least one method selected from the group consisting of a dry process, a wet process, an extraction process and a mixed process thereof.

Furthermore, the present invention provides a lithium ion polymer battery including a separator that is a polyolefin microporous membrane of which surface is modified with a hydrophilic polymer; a cathode; an anode; and an organic solvent-type electrolyte solution or a gel polymer electrolyte.

The organic solvent-type electrolyte solution contains at least one compound selected from chain type carbonate and cyclic carbonate, and the gel polymer electrolyte contains at least one polymer or copolymer selected from urethane and acrylate.

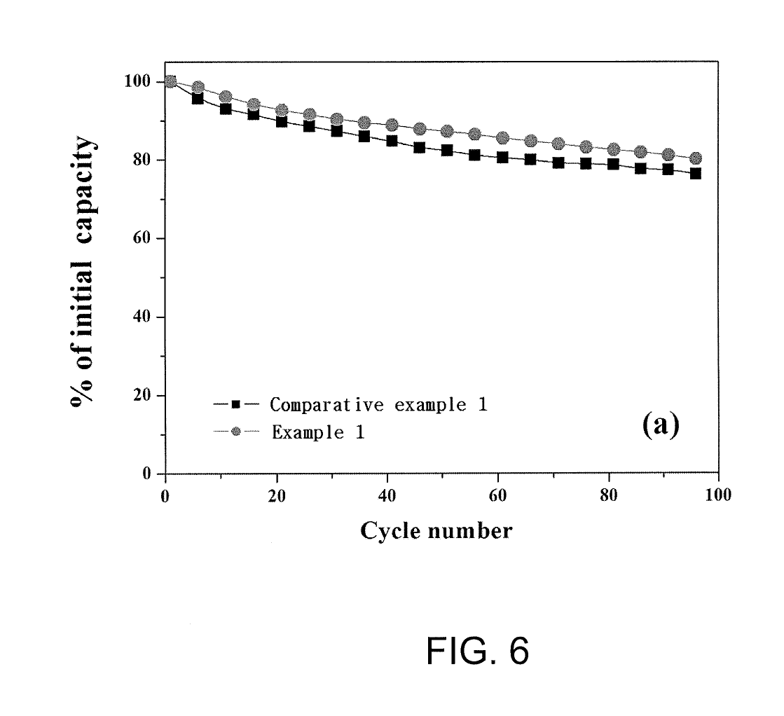

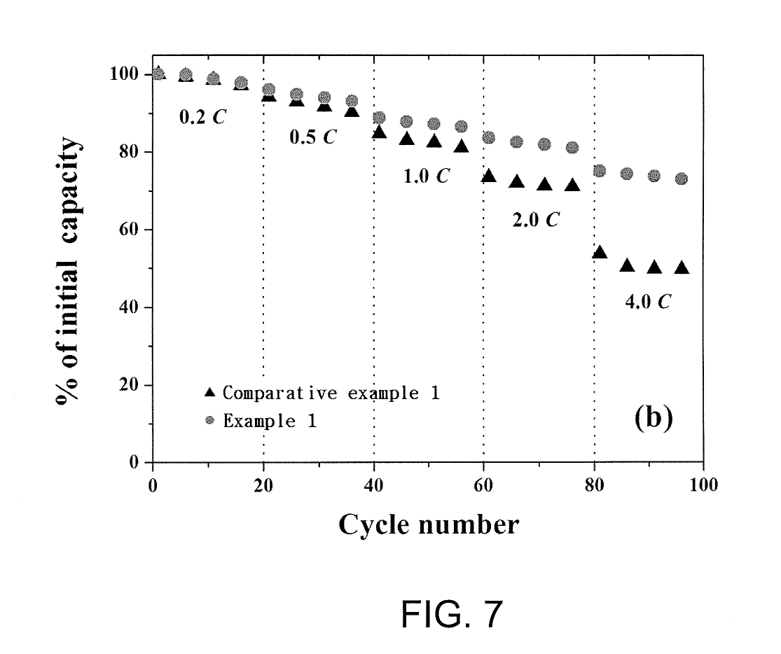

More preferably, the lithium ion polymer battery according to the present invention uses a polyolefin microporous membrane of which surface is modified with a hydrophilic acrylic polymer as a separator. Thus, the lithium ion polymer battery according to the present invention shows more than equal cycle life at room temperature in contrast with the existing lithium ion polymer battery (FIG. 6), and the rate capability of the lithium ion polymer battery is shown as enhanced cycle life even after charge-discharge cycle (FIG. 7).

Hereinafter, the present invention will be described in more detail with reference to examples. However, these examples are intended for describing the present invention in more specifically, and the scope of the present invention is not limited to these examples.

### Example 1

### Surface Modification of a Polyolefin Microporous Membrane

After a microporous membrane made of polyethylene was dipped in an acrylonitrile-containing solution for 5 minutes, the membrane was plasma treated for 10 minutes at 400 W in a plasma reactor to prepare a polyethylene microporous membrane of which both surfaces are coated with a polyacrylonitrile polymer.

### Example 2

### Preparation of a Lithium Ion Polymer Battery

Step 1: Preparation of an Organic Solvent-Type Electrolyte Solution and a Gel Polymer Electrolyte

Ethylene carbonate (EC):ethyl methyl carbonate (EMC):diethyl carbonate (DEC)=3:2:5 vol % of organic solvent was prepared, and 1.3M LiPF₆ as an electrolyte salt was dissolved in the resulting solution to prepare an organic solvent-type electrolyte solution.

Urethane acrylate (UA):hexyl acrylate (HA)=3:1 weight % of a polymer precursor and 2,2′-azobis(2,4-dimethylvaleonitrile) used as an initiator were dissolved in the organic solvent-type electrolyte solution prepared above to agitate sufficiently at room temperature, and then the resulting solution was subjected to polymerization reaction for 4 hours at 75° C. in a vacuum oven to prepare a gel polymer electrolyte.

Step 2: Preparation of a Lithium Ion Polymer Battery

A slurry mixed in the ratio of 96 wt % of LiCoO₂ as a cathode active material, 2 wt % of acetylene black as a conducting agent, 2 wt % of poly(vinylidene fluoride) (PVDF) as a binder was applied on an aluminum foil, and subjected to drying, pressure forming and heating treatment to prepare a cathode.

A slurry mixed in the ratio of 94 wt % of artificial graphite as an anode active material and 6 wt % of PVDF as a binder was applied on a copper foil, and subjected to drying, pressure forming and heating treatment to prepare an anode.

The gel polymer electrolyte prepared above and the polyolefin microporous membrane of which surface is modified by employing plasma-induced coating method in Example 1 as a separator between a cathode and an anode were used to prepare a lithium ion polymer battery.

### Comparative Example 1

The existing polyolefin microporous membrane was prepared without surface modification treatment employing plasma-induced coating method.

### Comparative Example 2

### Preparation of a Lithium Ion Polymer Battery

A lithium ion polymer battery was prepared in the same method as in Example 2 except that the polyethylene microporous membrane of the Comparative example 1 was used as it is as a separator.

### Experimental Example 1

### Surface Analysis by X-Ray Photoelectron Spectroscopy

Surface analysis for the polyethylene microporous membrane of Example 1 and Comparative example 1 was carried out by employing X-ray photoelectron spectroscopy (XPS, VG ESCALAB 220-I system), and the results are shown in Table 1 and FIG. 1 to 3 below.

TABLE 1
Result of surface analysis for a
polyethylene microporous membrane

| | Functional groups (%) | | | | |
|---|---|---|---|---|---|
| | C—C/C—H | C—O | C—N | C═O | C—O—O |
| Example 1 | 63.77 | 17.54 | 7.55 | 5.00 | 6.14 |
| Comp. | 98.37 | 1.16 | — | 0.26 | 0.21 |
| Example 1 | | | | | |

From the results shown in FIG. 1 to FIG. 3, it was observed that the polyolefin microporous membrane of which surface is modified according to the method of the present invention (FIG. 2) had functional groups of C—O, C—N, C═O, C—O—O and C—C/C—H on the membrane surface in contrast with the existing polyolefin microporous membrane without surface modification (FIG. 1). In addition, Table 1 and FIG. 3 shows distribution chart for functional groups observed on the surface of the polyolefin microporous membrane of Example 1 (FIG. 2). From the results, it was confirmed that the polymer was stably coated on the surface according to the surface modification method of the present invention.

### Experimental Example 2

### Experiment of Measuring Contact Angle

The surface energy of the polyolefin microporous membrane according to Example 1 and Comparative example 1 was calculated by math formula 1 and 2 below (S. Wu, Polymer Interface and Adhesion, Marcel Dekker, New York, 1982).

(1+cos θ)γ_{L}=2\sqrt{(γ_{L}^{d}·γ_{S}^{d})}+2\sqrt{(γ_{L}^{p}·γ_{S}^{p})} Formula 1

γ_{S}=γ_{S}^{d}+γ_{S}^{p} Formula 2

In the above formulae, θ is contact angle; γ_{L}, and γ_{S} are surface free energy of a test solution and a sample, respectively; and d and p represent dispersive component and polar component of surface energy, respectively. Surface free energy of two test solutions used in the present invention is γ_{L}=72.8, γ_{L}^{d}=21.8, γ_{L}^{p}=51.0 mJ/m² for water, and γ_{L}=50.8, γ_{L}^{d}=50.4, γ_{L}^{p}=0.4 mJ/m² for diiodomethane.

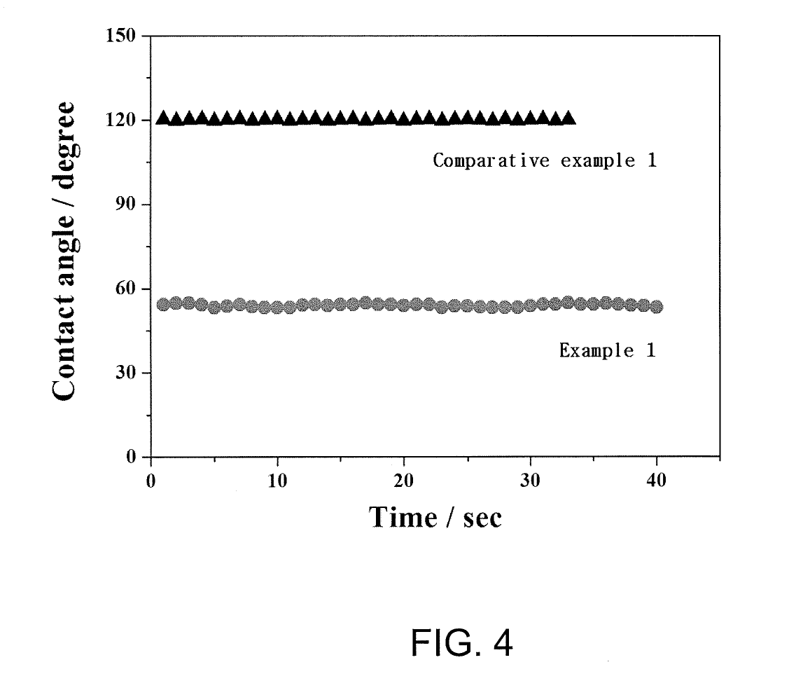

According to the above formulae 1 and 2, the surface characteristics for the surface modified polyethylene microporous membrane was calculated through measuring contact angle by formula 3 below, and the results are shown in Table 2 and FIG. 4.

Polarity(Xₚ)=γ_{S}^{p}/γ_{S} Formula 3

In the above formula, γ_{S}, γ_{S}^{d} and γ_{S}^{p} are the same as defined in the formulae 1 and 2.

TABLE 2
The results of surface characteristics for
the polyethylene microporous membrane

| | γ_{S} | γ_{S}^{d} | γ_{S}^{p} | Xₚ |
|---|---|---|---|---|
| Example 1 | 56.6 | 40.8 | 15.8 | 0.28 |
| Comparative | 30.3 | 28.9 | 1.4 | 0.05 |
| example 1 | | | | |

From the results of measurement for contact angle shown in FIG. 4, the polyethylene microporous membrane of Example 1 modified by employing plasma-induced coating method showed greatly decreased contact angle than that of Comparative example 1. Accordingly, from the result of the decreased contact angle for the polyethylene microporous membrane of Example 1 modified by employing plasma-induced coating method, it could be confirmed that surface free energy and polarity were increased (Table 2).

### Experimental Example 3

### Surface Measurement

The surface of the polyethylene microporous membrane of Example 1 and Comparative example 1 was analyzed by scanning electron microscope (SEM, JEOL 6340F SEM), and the results are shown in FIG. 5.

In FIG. 5, (a) and (b) are photographs observed with 5,000 and 30,000 magnifications, respectively, for the surfaces of the polyethylene microporous membrane of Comparative example 1, and (c) and (d) are photographs observed with 5,000 and 30,000 magnifications, respectively, for the surfaces of the polyethylene microporous membrane of Example 1. From the results, it could be observed that the polyethylene microporous membrane modified by employing plasma-induced coating method had a microporous polyethylene layer and a polymer-coating layer formed on its surface densely formed.

### Experimental Example 4

### Measurement of Ion Conductivity

Ion conductivity at room temperature for the polyethylene microporous membrane of Example 1 and Comparative example 1 was measured according to the AC complex impedance analysis (Solartron 1255 frequency response analyzer) using stainless electrodes, and the results are shown in Table 3 below.

TABLE 3
The results of measurement for ion conductivity
of the polyethylene microporous membrane

| | Ion conductivity at |
|---|---|
| | room temperature |
| Example 1 | 1.4 mS/cm |
| Comparative example 1 | 0.8 mS/cm |

From the results, it could be confirmed that the ion conductivity at room temperature for the polyethylene microporous membrane of Example 1 of which surface is modified by employing plasma-induced coating method according to the present invention was enhanced.

### Experimental Example 5

### Measurement of Mechanical Properties

Peel test for the polyethylene microporous membrane of Example 1 and Comparative example 1 was carried out at 10 mm/min of tensile speed at room temperature based on ASTM D638 by employing Universal Testing Machine (Instron, UTM). The results are shown in Table 4 below.

TABLE 4
The results of measurement for mechanical properties
of the polyethylene microporous membrane

| | Average load (N) | Peel strength (N/m) |
|---|---|---|
| Example 1 | 0.52 | 22.6 |
| Comparative example 1 | 0.44 | 19.1 |

From the results of Table 4, it could be confirmed that the mechanical properties for the polyethylene microporous membrane of Example 1 of which surface is modified by employing plasma-induced coating method according to the present invention was improved.

### Experimental Example 6

### Measurement (1) of Battery Characteristics

For the lithium ion polymer battery prepared in Example 2 and Comparative example 2, cycle life at room temperature (25° C.) was measured by charging the battery up to 4.2V at 1C charging speed, and then discharging to 3.0V at 1C discharging speed, and repeating the charge-discharge cycle with an experimental instrument (TOSCAT-300U instrument, Toyo System Co.). The results are shown in FIG. 6.

From the result of FIG. 6, it could be confirmed that the cycle life at room temperature for the lithium ion polymer battery prepared in Example 2 of which surface is modified by employing plasma-induced coating method according to the present invention was improved more than equal to the existing lithium ion polymer battery.

### Experimental Example 7

### Measurement (2) of Battery Characteristics

In order to measure battery characteristics for the lithium ion polymer battery prepared in Example 2 and Comparative example 2, the capacity of the lithium ion polymer battery was measured under the same condition as in Experimental example 6 except for varying charging-discharging speed. The rate capability for the lithium ion polymer battery was measured with capacity % remaining at each charge-discharge cycle vs capacity at one charge-discharge cycle, and the results are shown in FIG. 7. From the result of FIG. 7, it could be confirmed that the rate capability for the lithium ion polymer battery prepared in Example 2 of which surface is modified by employing plasma-induced coating method according to the present invention was shown as enhanced cycle life even after charge-discharge cycle in contrast with the existing lithium ion polymer battery.

As described in the above, firstly, the present invention provides a polyolefin microporous membrane, for a lithium ion polymer battery, of which surface is modified by a hydrophilic polymer.

Secondly, the present invention provides the surface modification method employing relatively simple and economical plasma-induced coating method, and thus can minimize membrane distortion and also increase the membrane's mechanical strength and heat resistance. In addition, the surface of polyolefin microporous membrane according to the present invention provides outstandingly enhanced ability of impregnating an electrolyte solution due to improvements of surface characteristics, e.g. increase in polarity and surface energy, through modification to hydrophilic surface.

Thirdly, the lithium ion polymer battery including a polyolefin microporous membrane of which surface is modified by a hydrophilic acrylic polymer according to the present invention as a separator shows enhanced uniformity of the electrolyte solution impregnated in a battery and a gel polymer electrolyte, and enhanced cycle life characteristics and rate capability. Further, such separator according to the present invention is effective in enhancing the stability of a lithium ion polymer battery.

While the present invention has been described with reference to the particular illustrative embodiments, it is to be appreciated that those skilled in the art can change or modify the embodiments without departing from the scope and spirit of the present invention, and such change and modification also pertain to appended claims.

1. A polyolefin microporous membrane of which surface is modified by a hydrophilic polymer through plasma treatment on one side or both sides of the polyolefin microporous membrane.

2. The polyolefin microporous membrane according to the claim 1, wherein the hydrophilic polymer is any one hydrophilic acrylic polymer selected from the group consisting of polyacrylonitrile, polyacrylic acid and polyacrylate.

3. The polyolefin microporous membrane according to the claim 1, wherein the hydrophilic polymer is any one selected from the group consisting of a derivative, a copolymer and a blend of a hydrophilic acrylic polymer, in which a C₁˜C₁₀ alkyl group or a C₁˜C₁₀ alkoxy group is substituted on any one hydrophilic acrylic polymer selected from the group consisting of polyacrylonitrile, polyacrylic acid and polyacrylate.

4. The polyolefin microporous membrane according to the claim 1, wherein the polyolefin microporous membrane is any one selected from the group consisting of polyethylene, polypropylene, polyvinylidene fluoride and poly(vinylidenefluoride hexafluoropropylene); or a mixed form selected from a copolymer thereof and a blend thereof.

5. The polyolefin microporous membrane according to the claim 4, wherein the blend is a microporous membrane form having a multi-layer structure made of polyethylene/polypropylene or polypropylene/polyethylene/polypropylene.

6. A method of modifying a surface of a polyolefin microporous membrane comprising the steps of activating a plasma reactor by feeding a reaction gas into the plasma reactor, and plasma-treating the polyolefin microporous membrane so that a hydrophilic polymer can be coated on one side or both sides of the membrane within the activated plasma reactor.

7. The method of modifying a surface of a polyolefin microporous membrane according to claim 6, wherein the surface is modified by polymerizing monomers of the hydrophilic polymer on one side or both sides of the polyolefin microporous membrane by plasma treatment.

8. The method of modifying a surface of a polyolefin microporous membrane according to claim 6, wherein the hydrophilic polymer is any one hydrophilic acrylic polymer selected from the group consisting of polyacrylonitrile, polyacrylic acid and polyacrylate.

9. The method of modifying a surface of a polyolefin microporous membrane according to claim 6, wherein the hydrophilic polymer is any one selected from the group consisting of a derivative, a copolymer and a blend of a hydrophilic acrylic polymer, in which a C₁˜C₁₀ alkyl group or a C₁˜C₁₀ alkoxy group is substituted on any one hydrophilic acrylic polymer selected from the group consisting of polyacrylonitrile, polyacrylic acid and polyacrylate.

10. The method of modifying a surface of a polyolefin microporous membrane according to claim 6, wherein the pressure in the activated plasma reactor is 0.01 to 1,000 mTorr.

11. The method of modifying a surface of a polyolefin microporous membrane according to claim 6, wherein the flux of the reaction gas in the activated plasma reactor is 10 to 1,000 sccm.

12. The method of modifying a surface of a polyolefin microporous membrane according to claim 6, wherein the plasma treatment is carried out under the condition of plasma power of 1 to 500 W and plasma coating time of 30 seconds to 30 minutes.

13. The method of modifying a surface of a polyolefin microporous membrane according to claim 6, wherein the polyolefin microporous membrane is prepared by at least one method selected from the group consisting of a dry process, a wet process, an extraction process and a mixed process thereof.

14. A lithium ion polymer battery including a separator that is a polyolefin microporous membrane of which surface is modified with a hydrophilic polymer according to claim 1; a cathode; an anode; and an organic solvent-type electrolyte solution or a gel-type polymer electrolyte.

15. A lithium ion polymer battery including a separator that is a polyolefin microporous membrane of which surface is modified with a hydrophilic polymer according to claim 2; a cathode; an anode; and an organic solvent-type electrolyte solution or a gel-type polymer electrolyte.

16. A lithium ion polymer battery including a separator that is a polyolefin microporous membrane of which surface is modified with a hydrophilic polymer according to claim 3; a cathode; an anode; and an organic solvent-type electrolyte solution or a gel-type polymer electrolyte.

17. A lithium ion polymer battery including a separator that is a polyolefin microporous membrane of which surface is modified with a hydrophilic polymer according to claim 4; a cathode; an anode; and an organic solvent-type electrolyte solution or a gel-type polymer electrolyte.

18. A lithium ion polymer battery including a separator that is a polyolefin microporous membrane of which surface is modified with a hydrophilic polymer according to claim 5; a cathode; an anode; and an organic solvent-type electrolyte solution or a gel-type polymer electrolyte.
